(19) United States
(12) Patent Application Publication
(10) Pub. No.: US 2006/0043222 A1
(43) Pub. Date: Mar. 2, 2006

(54) Ice scraping machine

(76) Inventor: Ming-Tsung Lee, Tainan City (TW)

Correspondence Address: Ming-Tsung Lee, P.O. Box 90, Tainan City, 704, TW

(21) Appl. No.: 10/928,093

(22) Filed: Aug. 30, 2004

(51) Int. Cl. B02C 17/02

(52) U.S. Cl. 241/92

(57) ABSTRACT

An ice scraping machine includes a machine base having an ice container with a scraper disk provided on the topside, a machine body covered on the ice container and having a trigger switch, a motor, a transmission gear unit and a push rod, and an upper cover provided with a press switch and a press rod. When the machine body is covered on the machine base, the ice container will press the lower end of the push rod to let its upper end deflect outward not to push against the press rod, letting the press switch able to be pressed downward to compress the trigger switch to start the motor for ice scraping. If the machine body is disengaged from the machine base, the push rod will recover to push against the bottom of the press rod, letting the press switch impossible to be pressed downward to ensure safety in use.

### BACKGROUND OF THE INVENTION

1. Field of the Invention

This invention relates to an ice-scraping machine, particularly to one provided with a machine base, a machine body and an upper cover. The machine base has its topside provided with an ice container having a scraper disk with a scraper provided at the bottom. The machine body to be covered on the ice container of the machine base is provided with a motor holder having a trigger switch, a motor and a transmission gear unit installed in the interior, a rotating shaft, an ice-pressing rotary disk, a chamber, and a push rod. The upper cover to be threadably assembled on the topside of the machine body is provided with a press switch and a press rod. When the machine body is covered on the machine base, the ice container will move in the chamber of the machine body to push the lower end of the push rod of the machine body to let the upper end of the push rod move bias not to push against the press rod of the upper cover. Thus, the press switch of the upper cover can be pressed downward to let the press rod touch and press the trigger switch of the machine body to start the motor to carry out ice scraping. If the machine body is disengaged from the machine base, the push rod of the machine body will recover to push against the bottom of the press rod of the upper cover to make the press switch of the upper cover fail to be pressed downward, ensuring safety in use.

2. Description of the Prior Art

Generally, a conventional ice-scraping machine is not provided with any safety device. In using, an ice block is placed on an ice-supporting member and has its topside pressed and gripped firmly by an ice-pressing rotary member. Then, press down a press button to let the ice-pressing rotary member rotate together with the ice block, and synchronously the scraper positioned at the bottom of the ice-supporting member begins scraping on the ice block, thus obtaining scraped ice. However, if the press button is pressed (or pressed carelessly) before the ice block is pressed and gripped firmly by the ice-pressing rotary member, it is impossible to carry out ice scraping and the ice block is likely to fly away and possible to cause an unexpected accident.

### SUMMARY OF THE INVENTION

The objective of the invention is to offer an ice-scraping machine, able to ensure safety in use.

The ice-scraping machine of this invention includes a machine base, a machine body and an upper cover. The machine base has its upper side provided with an ice container having a scraper disk with a scraper provided at the bottom. The machine body to be covered on the ice container of the machine base is provided inside with a motor holder having a trigger switch, a motor and a transmission gear unit installed in the interior. The motor holder has a rotating shaft extending downward from the lower center to be threadably combined with an ice-pressing rotary disk having numerous claw-shaped teeth formed on the surface. A chamber is formed between the motor holder and the inner wall of the machine body, and a push rod is provided at one side of the motor holder, having its lower end formed with a press member extending to the chamber. The upper cover to be threadably assembled on the machine body has a press switch provided on the topside and a press rod extending downward from one side and corresponding to the push rod and the trigger switch of the machine body.

### BRIEF DESCRIPTION OF DRAWINGS

This invention will be better understood by referring to the accompanying drawings, wherein:

FIG. 1 is an exploded perspective view of an ice-scraping machine in the present invention;

FIG. 2 is an exploded perspective view of the machine body and the upper cover of the ice-scraping machine in the present invention;

FIG. 3 is a cross-sectional view of the ice-scraping machine in the present invention; and,

FIG. 4 is a cross-sectional view of the ice-scraping machine in a using condition in the present invention.

### DETAILED DESCRIPTION OF THE PREFERRED EMBODIMENT

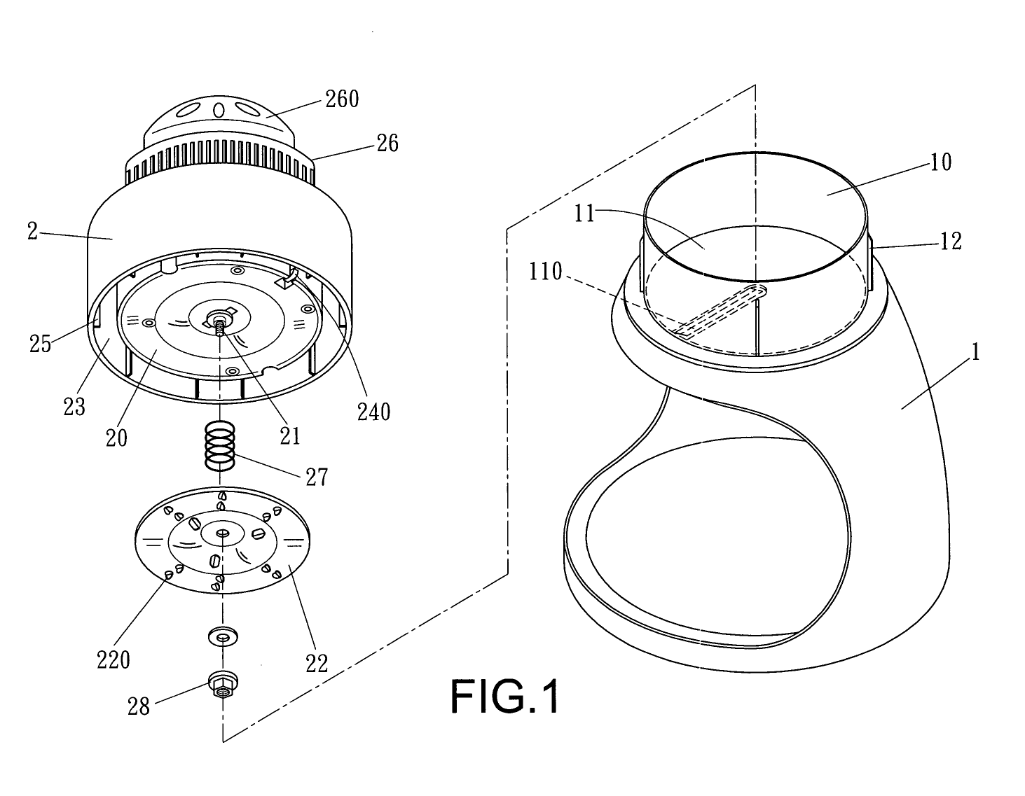

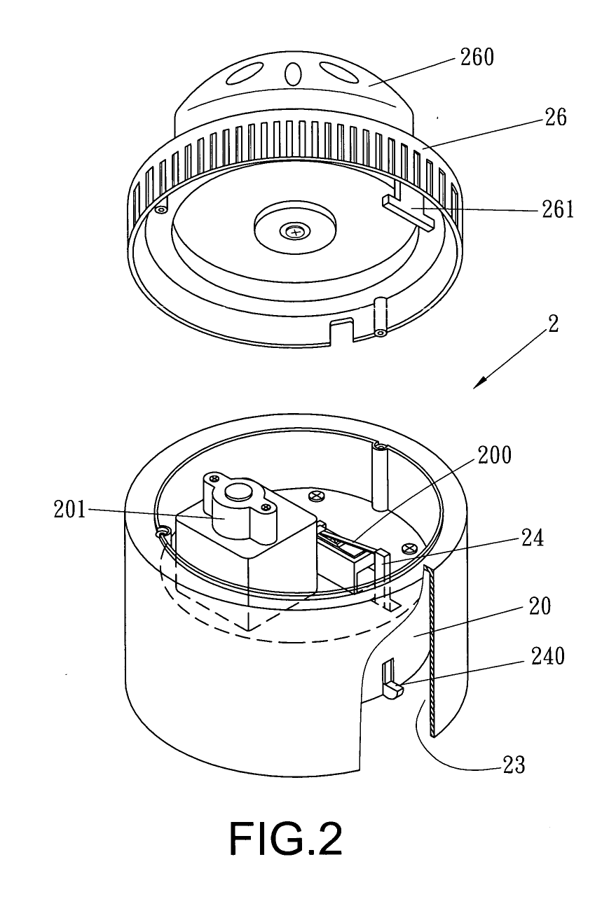

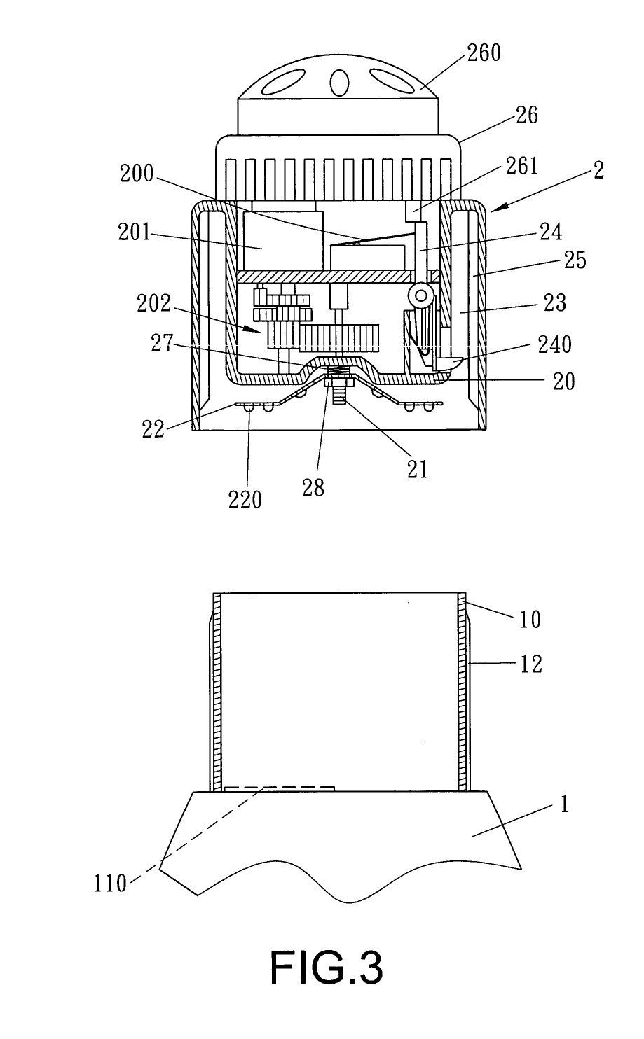

A preferred embodiment of an ice-scraping machine in the present invention, as shown in FIGS. 1, 2 and 3, includes a machine base 1, a machine body 2 and an upper cover 26 combined together.

The machine base 1 has its upper side provided with an ice container 10 having a scraping disk 11 with a scraper 1 10 provided at the bottom. The ice container 10 has its outer wall provided with a plurality of vertical elongate projections 12.

The machine body 2 to be covered on the ice container 10 of the machine base 1 is provided with a motor holder 20 having a trigger switch 200, a motor 201 and a transmission gear unit 202 installed inside. The motor holder 20 is further provided in the center with a rotating shaft 21 extending downward to be fitted thereon with a spring 27 and then threadably combined with an ice-pressing rotary disk 22 by a threaded member 28, with numerous claw-shaped teeth 220 formed on the surface of the ice-pressing rotary disk 22. An annular chamber 23 is formed between the motor holder 20 and the inner wall of the machine body 2, and a push rod 24 is provided at one side of the motor holder 20, having its lower end formed with a push-and-press member 240 extending to the chamber 23. Further, the machine body 2 has its inner wall provided with a plurality of engage ribs 25.

The upper cover 26 to be threadably assembled on the topside of the machine body 2 has a press switch 260 provided on the topside and a press rod 261 extending downward from a spot on an inner side and aligned to the positions of the push rod 24 and the trigger switch 220 of the machine body 2.

In assembling, as shown in FIGS. 1, 2 and 3, firstly, the rotating shaft 21 of the machine body 2 is fitted thereon with the spring 27 and then threadably combined with the ice-pressing rotary disk 22 by the threaded member 28. Next, the upper cover 26 is threadably assembled on the topside of the machine body 2, letting the press rod 261 of the upper cover 26 and the push rod 24 of the machine body 2 aligned to each other. At this time, the push rod 24 has its upper end pushing against the bottom of the press rod 26 so the press switch 260 of the upper cover 26 cannot be pressed downward.

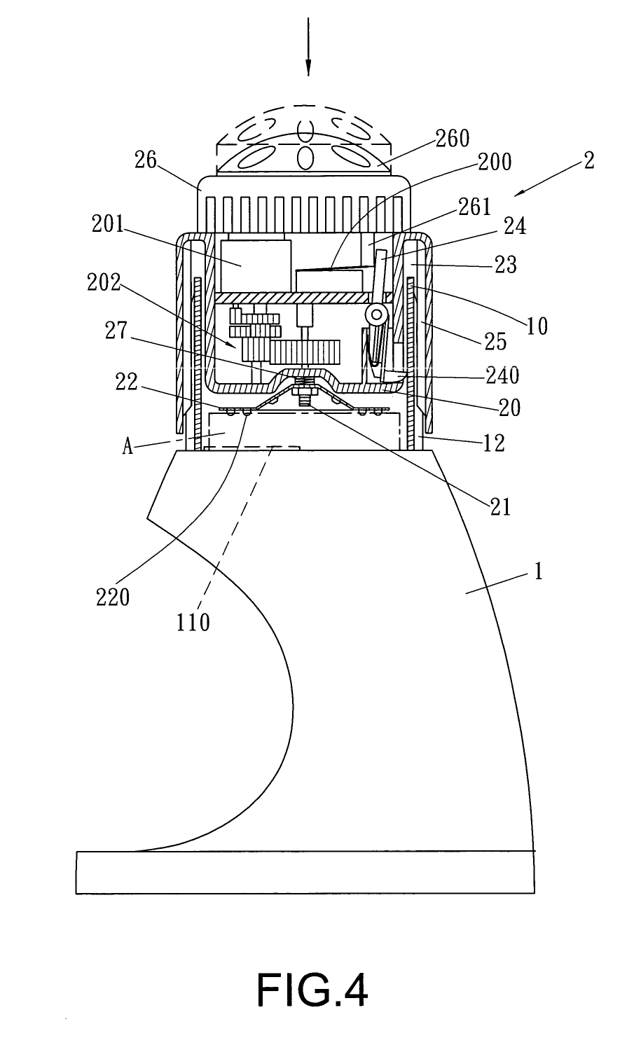

In using and operating, as shown in FIGS. 1, 3 and 4, an ice block (A) is placed in the ice container 10 at the topside of the machine base 1 and the machine body 2 is covered around the ice container 10, letting the elongate projections 12 on the outer side of the ice container 10 engaged with the engage rib 25 on the inner wall of the machine body 2 and having the claw-shaped teeth 220 of the ice-pressing rotary disk 22 in the machine body 2 tightly gripping the ice block A. When inserted in the chamber 23 of the machine body 2, the ice container 10 will force the push-and-press member 240 at the end of the push rod 24 to move inward and the upper end of the push rod 24 to deflect outward and no longer push against the press rod 261 of the upper cover 26. At this time, only press down the press switch 260 of the upper cover 26, and the press rod 260 will move downward to press the trigger switch 200 of the machine body 2 to start the motor 201 to drive the transmission gear unit 202 to rotate and actuate the rotating shaft 21 to rotate together with the ice-pressing rotary disk 22 and the ice block A, and the scraper 110 on the scraper disk 11 at the bottom of the ice container 10 will synchronously carry out ice scraping. If the press switch 260 of the upper cover 26 is released, the press rod 261 of the upper cover 26 will move upward not to compress the trigger switch 200 any longer to form an electrically disconnected condition and stop ice scraping, able to ensure safety in operation of ice scraping.

Specifically, when the machine body 2 is covered on the ice container 10 of the machine base 1, the ice container 10 will move in the chamber 23 of the machine body 2 and force the push-and-press member 240 at the end of the push rod 24 to move inward and the upper end of the push rod 24 to deflect outward not to push against the bottom of the press rod 261 of the upper cover 26. Thus, the press switch 260 of the upper cover 26 can be pressed downward to make the press rod 261 compress the trigger switch 200 of the machine body 2 to start the motor 201 for carrying out ice scraping. On the contrary, if the press switch 260 is released, the press rod 261 will move upward and disconnect the trigger switch 200 to form an electrically disconnected condition. In addition, when the machine body 2 is disassembled from the ice container 10 of the machine base 1, the push rod 24 in the machine body 2 will immediately recover to push against the bottom of the press rod 261 of the upper cover 26 to let the press switch 260 unable to be pressed downward, ensuring safety in use.

While the preferred embodiment of the invention has been described above, it will be recognized and understood that various modifications may be made therein and the appended claims are intended to cover all such modifications that may fall within the spirit and scope of the invention.

What is claimed is:

1. An ice scraping machine comprising:
a machine base having an ice container provided on a topside, said ice container provided with a scraper disk with a scraper at the bottom;
a machine body covered on said ice container of said machine base, said machine body provided with a motor holder in the interior, said motor holder provided inside with a trigger switch, a motor and a transmission gear unit, said motor holder further provided with a rotating shaft extending downward from its center, said rotating shaft threadably combined with an ice-pressing rotary disk, said ice-pressing rotary disk formed with numerous claw-shaped teeth, an annular chamber formed between said motor holder and the inner wall of said machine body, said motor holder having one side provided with a push rod, said push rod having its lower end provided with a push-and-press member extending in said annular chamber; and,
an upper cover threadably assembled on said machine body, said upper cover provided with a press switch on the topside, said upper cover having one inner side provided with a press rod extending downward, said press rod of said upper cover aligned to said trigger switch of said machine body.

2. The ice scraping machine as claimed in claim 1, wherein said ice container of said machine base has its outer wall provided a plurality of vertical elongate projections, and said machine body has its inner wall provided with a plurality of engage ribs for respectively engaging said elongate projections of said ice container.
